(19) United States
(12) Patent Application Publication
(10) Pub. No.: US 2018/0089323 A1
(43) Pub. Date: Mar. 29, 2018

(54) Method of Credit on the Social Network Site

(71) Applicant: Shijie Yan, Shenzhen (CN)

(72) Inventor: Shijie Yan, Shenzhen (CN)

(21) Appl. No.: 15/657,200

(22) Filed: Jul. 23, 2017

(30) Foreign Application Priority Data
Sep. 28, 2016 (CN) 201610860839.1

(51) Int. Cl. G06F 17/30; G06Q 50/00; G06Q 10/00

(52) U.S. Cl. CPC G06F 17/30867; G06Q 50/01; G06F 17/30424; G06F 17/30699; G06Q 10/00; G06F 17/3053

(57) ABSTRACT

The disclosure provides a method of credit on the social network site, wherein the social level is mapped reasonably and logically by doing statistical analysis of functions used by the user on the site and various credits obtained according to the rules of the site, and the permission of using site functions is divided strictly for the user corresponding to the level, to establish a credit system for the user on the social network site. According to the disclosure, comprehensive rule design: the investigation of user activeness can be as comprehensive and accurate as possible; reasonable level design: the user's potential “aggressiveness” (activeness) is motivated to promote the interactivity of the site and maintain the credibility of the site; strict permission design: it has an effect of “rewarding good performance and punishing poor performance” on the user and an effect of “survival of the fittest” on the content.

### BACKGROUND OF THE INVENTION

### 1. Field of the Invention

The disclosure relates to the field of site technology, and more particularly to a method of credit on the social network site.

### 2. Description of Related Art

In the existing (content-based) social network site, the commonly used user level system is for the statistics with a single data indicator (for example, the “online time” is mapped to the user credit); the user level often exists only as the arithmetic sorting or primary counting and the level generally does not strictly correspond to the site permission (excluding the sites providing services after payment); there are also some sites without the user level system, only the statistics of number of contents output by the user and interaction state on the site is carried out.

At present, the “user level” that widely exists in the social network sites often only exists spontaneously as primary sorting and counting functions and the logic design of comprehensive, reasonable and strict credit system (rule, level and permission) is not carried out, so it is also very limited to the promotion of the user activeness and the reflection of differentiation between users; it is lack of comprehensive rule design and the investigation of the user activeness is naturally one-sided and inaccurate, so that the user (and content output by the user) often has a low credibility; it is lack of reasonable level design and the user's potential “aggressiveness” (activeness) cannot be motivated, so that the site interaction is not strong and the site often is lack of credibility; it is lack of strict permission design, so that there is no an effect of “rewarding good performance and punishing poor performance” on the user and it will not imperceptibly guide the user to comply with the rules, resulting in the spread of low-quality content.

### SUMMARY OF THE DISCLOSURE

An object of the disclosure is to provide a method of credit on the social network site to solve the problem that the “user level” that widely exists in the social network sites often only exists spontaneously as primary sorting and counting functions at present and the logic design of comprehensive, reasonable and strict credit system (rule, level and permission) is not carried out, so it is also very limited to the promotion of the user activeness and the reflection of differentiation between users.

The disclosure is realized as the following: a method of credit on the social network site, wherein the social level is mapped reasonably and logically by doing statistical analysis of functions used by the user on the site and various credits obtained according to the rules of the site, and the permission of using site functions is divided strictly for the user corresponding to the level, to establish a credit system for the user on the social network site.

Further, the method of credit on the social network site comprises the credit rule and the star level setting, wherein the credit rule and star level setting method comprises: The site user can get a high star level by publishing articles to get the corresponding credits and appreciation number; when a user publishes articles, the corresponding credits are recorded in the database for the user and the user's credits will be accumulated and saved; when the user's articles get the appreciation of other users, the appreciation is accumulated and saved in the field of getting appreciation of the user;

When it is required to display the star level of a user, the user's credits and appreciation number are called by searching session information (unique number of the user) saved by the user in the database when logging into the site, and the star level rule function is called and the credits and appreciation number are used as the parameters and passed into the function, and then the user's star level is returned through the calculation with the star level definition formula.

Further, to ensure a good operation of the credit rule and the star level setting on the large-user and high-concurrency site, the credit rule and star level setting method comprises:

First, the load pressure on the database server brought by the credit rule and appreciation rule is relieved by using the database master-slave separation technology;

Second, the huge load on the database server brought by the operation of clicking appreciation by a large number of users who concurrently access to the site is relieved by using the asynchronous technology and queue technology; after the user clicks appreciation, the appreciations on the page are accumulated with javascript, and then the number is put into the appreciation update queue and updated from the queue to the database, to cancel the high concurrent operation of appreciate function by a large number of users, and the peak clipping processing is carried out to speed up the response to the user.

Further, the use of the database master-slave separation technology comprises:

The database server is set to the master database and slave database;

The user obtains the credits and appreciation number by a large number of write operations and connects the write operation data to the master database;

When the star level is displayed, the user obtains and displays the user's credits and appreciation number from the database and performs the calculation; When the latest data is read from two database servers with data consistency, the data from the master and slave servers are synchronized.

Further, the method of credit on the social network site comprises a real-name authentication method and a qualification authentication method, wherein the real-name authentication method comprises:

After logging into the site, the user uploads the original documents that cannot be altered for applying for the real-name authentication; after the pictures of the uploaded documents are selected, the types of the uploaded documents are also required to be selected, including ID card, passport, driver's license and pass into Hong Kong and Macao; the real name, ID number and phone number must be entered; if the information is not filled in completely, the front-end verification and back-end verification on the site page will intercept the user and stop the user to submit the documents;

After the user submits a real name application, it is required to wait for the review by the administrator and the administrator enters the site background to view the information and documents submitted by the user; after it is determined that the documents uploaded and information entered by the user are correct through the review by the administrator, the real-name authentication application of the user is opened in the background; after passing the real-name authentication review, the real-name authentication mark can be seen by entering the user's space;

The qualification authentication method comprises:

Before uploading the qualification certificates, the user needs to pass the real-name authentication.

The user needs to upload the originals and public versions of qualification certificates; after the user submits the qualification certificates, it is required to wait for the review by the administrator and the administrator enters the background to review the original qualification certificates submitted by the user; after passing the review by the administrator, the administrator opens the qualification certificate display permission in the background, so that other users can enter the user's space to view the user's qualification certificates.

Further, to ensure that the real-name authentication and qualification authentication functions do not affect the performance of the Web application server and to provide the user with a better experience, the method of credit on the social network site comprises:

(a) Creating a real-name authentication static resource folder real name and a qualification authentication static resource folder aptitude on a file server built through a standalone server respectively to store the static resource files uploaded by the user and setting the corresponding read and write permissions for folders respectively;

(b) Creating a second-level domain user.youshizhishi.com for the independent access to the real-name authentication and qualification authentication resource files;

(c) Directly uploading the real-name authentication and qualification authentication resource files uploaded by the user to the file server through the second-level domain user.youshizhishi.com on the site;

(d) Accelerating the second-level domain user.youshizhishi.com by using CDN, so that the source station points to the second-level domain and the second-level domain is configured with a security chain and access white list;

(e) In the developed site code, the real-name authentication and qualification authentication static resource files uploaded by the user and addresses of access to these files directly use the independent second-level domain user.youshizhishi.com. The method of credit on the social network site according to the disclosure, wherein comprehensive rule design: the investigation of user activeness can be as comprehensive and accurate as possible so that the user (and content output by the user) is highly credible; credits are one of the bases of user star level; on the content-based social network site, the user needs to get credits by publishing (high-quality) articles and providing (high-quality) download resources or by providing (high-quality) articles and Q & A contents to attract other users to comment them, thus providing a more comprehensive reflection of the interaction among users on the social network site; getting the “appreciation” of other users is also one of the bases of user star level; it reflects the user activeness and the user needs to obtain the public recognition; therefore, it can more accurately reflect the effectiveness of user activeness.

Reasonable level design: the user's potential “aggressiveness” (activeness) is motivated to promote the interactivity of the site and maintain the credibility of the site; when the user star level is upgraded to the “authority” and “expert” level, the (real-name and qualification) authentication shall be passed and the public recognition is also required to be obtained for the submitted qualification required for “expert” certification (to achieve a certain “appreciation number”), so that the star level design becomes a concentrated reflection of professionalism and credibility of the user, thus effectively guaranteeing the authority of the user level and stimulating the user to make efforts to a higher level of “honor”. The user star level may be degraded by deducting the credits due to the violation of words and deeds, which will prompt the user to be responsible for the published contents, thus maintaining the overall quality of contents on the site.

Strict permission design: it has an effect of “rewarding good performance and punishing poor performance” on the user and an effect of “survival of the fittest” on the content; it will imperceptibly guide the user to comply with the rules to effectively guide the output of high-quality content. The relatively high-level user has limit permissions for the relatively low-level user, for example, the user can set the star level limits for comments on articles published by the user in the article and Q & A section of the site, attachment download and answer to the question, thus effectively reflecting the difference of the level and encouraging the output of high-quality content. After passing the (real-name and qualification) authentication, the user level can be upgraded to the “authority” and “expert” level (the public recognition is also required to be obtained for the submitted qualification required for “expert” certification to achieve a certain “appreciation number”). The “authority” and “expert” level of users will be prominently marked on the site and are more likely to be concerned and asked for help by other users in the site contents (articles and Q & A), thus better reflecting the social value of professional and credible users.

### BRIEF DESCRIPTION OF THE DRAWINGS

FIG. 1 is a schematic diagram of the method of credit on the social network site according to embodiments of the disclosure;

### DETAILED DESCRIPTION OF THE PREFERRED EMBODIMENT

The disclosure will now be described in detail with reference to the embodiments to more clearly clarify the purpose, technical solution and advantages of the disclosure. It should be understood that the preferred embodiments described herein are only to explain the disclosure and are not intended to limit the disclosure.

When the “person of insight” site is developed, the site operation speed, high concurrent access to the site, site security, costs of site development, the user's habits, etc. are considered comprehensively; the current mature Microsoft .NET platform system is adopted and the main development language is C# language; meanwhile popular Web development technologies such as jQuery, Ajax, JSON and HTML5 are integrated to bring a good experience for the user.

Microsoft SQL Server is used in the data storage.

The application principle of the disclosure will be further described below in combination with the attached drawings and specific embodiments.

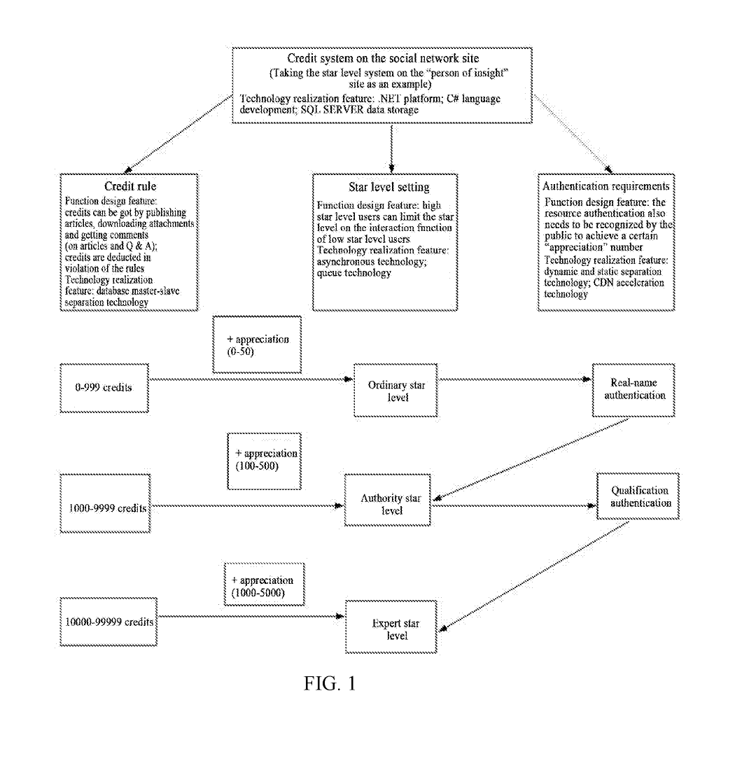

As shown in FIG. 1, the method of credit on the social network site according to embodiments of the disclosure, wherein the social level is mapped reasonably and logically by doing statistical analysis of functions used by the user on the site and various credits obtained according to the rules of the site, and the permission of using site functions is divided strictly for the user corresponding to the level, to establish a credit system for the user on the social network site.

The application principle of the disclosure will be further described below in combination with specific embodiments.

1. Credit Rule and Star Level Setting Method:

The site user can get a high star level mainly by publishing articles to get the corresponding credits and appreciation number; when a user publishes an article, the corresponding credits are recorded in the database for the user (if the article is original, 10 credits are recorded; if the article is translation version, 5 credits are recorded; if the article is reprinted, 2 credits are recorded) and the user's credits will be accumulated and saved; when the user's article gets the appreciation of other users, the appreciation is accumulated and saved in the field of getting appreciation of the user.

When it is required to display the star level of a user, the user's credits and appreciation number are called by searching session information (“unique number of the user”) saved by the user in the database when logging into the site, and the star level rule function is called and the credits and appreciation number are used as the parameters and passed into the function, and then the user's star level is returned through the calculation with the above star level definition formula.

To ensure a good operation of the credit rule and the star level setting on the large-user and high-concurrency site, the following technologies are used in the disclosure:

First, to relieve the load pressure on the database server brought by the credit rule and appreciation rule, the database master-slave separation technology is used,

1) Two database servers are configured; one is used as the master database and the other is used as the slave database;

2) The user gets the credits and appreciation number by a large number of write operations and puts the write operations in the master database, that is, connects the write operation data to the master database;

3) It is required to get the user's credits and appreciation number to perform the calculation when displaying the user star level and the data is read from the second database for display;

4) To ensure the consistency of the data in two database servers, the data from the master and slave servers are synchronized to ensure that the data read from the database is up-to-date;

5) The separation of the master database and the slave database not only greatly reduces the load pressure on the database server, but also plays a role of redundant backup in the data security.

Second, to solve the huge load on the database server brought by the operation of clicking “appreciation” by a large number of users who concurrently access to the site, in addition to the master-slave read and write separation processing of the above database server, the asynchronous technology and the queue technology are used; after the user clicks “appreciation”, the appreciations on the page are accumulated with javascript technology, and then the number is put into the appreciation update queue and updated from the queue to the database, so that the peak clipping processing is completed for high concurrent operation of appreciate function by a large number of users, which not only improves the throughput efficiency of the site, but also greatly accelerates the response to the user to enhance the user experience.

The star level setting comprises:

For the star level setting of the user on the “person of insight” site, the user can get the credits and appreciation number by publishing articles, providing attachments to be downloaded and raising comments on articles and questions and answers to become a high level user, namely, “expert” and “authority” level user; the “identity” is built by the user itself. Similar to the game; the user level can be upgraded to a higher level when the user meets the specified requirements of each level.

Based on the comprehensive activeness of the user on the site, there are a total of three major levels of 16 star levels (the upper limit of user star level can be increased reasonably based on the actual development of the site): “ordinary” star level is subdivided into 6 star levels (level 0˜5, including level 0 for original members); “authority” star level is subdivided into 5 star levels (level 1˜5); “expert” star level is subdivided into 5 star levels (level 1˜5); the user star level is divided into ordinary star level→authority star level→expert star level from low to high.

(a) Ordinary Star Level

The level of all registered users on the “person of insight” site (hereinafter referred to as “users of insight”) are divided into 6 star levels (level 0˜5, including level 0 for original members) from the beginning of the registration (to reach the “authority star level”) based on the credits and appreciation number of these users, namely, level 0, level 1, level 2, level 3, level 4 and level 5.

It is required to get 100N credits and 10N appreciations for each star level upgrade (N≧1). The star level credit range is 10N≦credits≦10(N+1)−1. (N is ordinary star level).

(b) Authority Star Level

When a user of insight gets 1000 credits and 100 “appreciations” by publishing articles and the user passes the real-name authentication, the user level is upgraded to the authority star level.

The authority star level is subdivided into 5 levels, namely, authority level 1, authority level 2, authority level 3, authority level 4 and authority level 5.

It is required to get 1000M credits and 100M appreciations for each authority star level upgrade (M≧1). The star level credit range is 1000M≦credits≦1000(M+1)−1. (M is authority star level).

(c) Expert Star Level

When a user of insight gets 10000 credits and 1000 “appreciations” for the published articles and 1000 appreciations for qualifications uploaded by the user (the number of appreciations for qualifications is calculated separately), the user level is upgraded to the expert star level.

The expert star level is subdivided into 5 levels, namely, expert level 1, expert level 2, expert level 3, expert level 4 and expert level 5.

It is required to get 10000X credits and 1000X appreciations for each expert star level upgrade (X≧1). The star level credit range is 10000X≦credits≦10000(X+1)−1. (X is expert star level).

(d) Star Level Permissions

The relatively high-level user has limit permissions for the relatively low-level user:

The user of insight can limit the star level of users to comment on the published articles, answer the questions and download the resources (attachments) (the star level of the answerer can be selected when publishing the questions and the star level of users who download the attachments can be specified when publishing the attachments); however, it is only limited to other users of insight that the star level is below that of the user (including the same star level of users). For example, if the star level limit is level 2 or above, the user below level 2 cannot perform the commenting, answering and download.

If the star level limit is higher than the user's level, the user needs to cross the star level limit to contribute a certain amount of money to the site system as the cross-level fees; for the limit to the relatively high-level user, the relatively low-level user can also break through the limit by contributing a certain amount of money to the site system. If there is a conflict, the selection of the former (limiter) shall prevail.

The credit rule comprises:

Credits are one of the important indicators of the user of insight to upgrade the star level; the credits can be increased or may be deducted (the corresponding credits will be deducted when downloading attachments and the corresponding credits will be punished when violating the site rules); the credits can be got by publishing articles, downloading attachments and commenting on articles and Q & A.

(a) Publishing Articles

When publishing an article, the user of insight can get different credits (+10 credits for the original article, +5 credits for the translated article and +2 credits for the reprinted article) based on the type of the article;

(b) Downloading Attachments

If the attachment to the article provided by a user of insight with the credits as a reward is downloaded, the user will get credits based on the previous setting (the corresponding credits of the other user will be deducted)

(c) Commenting on Articles and Q & A

If other users comment on the article or answer published by a user of insight, the users who give comments can get 1 credit. (Regardless of the user star level and number of comments, the corresponding credits are got only based on the number of users who give comments).

(d) Credits Deduction

To maintain the seriousness of the star level of the user of insight and the credit setting, the “person of insight” site will promote the user to be responsible for the published works and the words and deeds. 10 credits will be deducted automatically for each deletion; if the user of insight is reported to have bad, untrue and improper remarks, after the check and verification, in addition to the deletion of relevant contents, 20 credits will be deducted.

2. Real-Name Authentication and Qualification Authentication Method:

1) Realization of Real-Name Authentication:

The user can apply for the real-name authentication on the site; after the real-name authentication of the user is completed, other users can enter the user's space to view the real-name authentication mark of the user, which can greatly enhance the user's credit on the site.

If the user applies for the real-name authentication, the user must upload the documents after logging into the site and the uploaded documents must be original and cannot be altered; after the pictures of the uploaded documents are selected, the types of the uploaded documents are also required to be selected, including ID card, passport, driver's license and pass into Hong Kong and Macao, and the real name, ID number and phone number must be entered. If the information is not filled in completely, the front-end verification and back-end verification of the site page will intercept the user and prevent the user to submit the documents.

After the user submits a real name application, it is required to wait for the review by the administrator and the administrator enters the site background to view the information and documents submitted by the user; after it is determined that the documents uploaded and information entered by the user are correct through the review by the administrator, the real-name authentication application of the user is opened in the background. After passing the real-name authentication review, the real-name authentication mark can be seen by entering the user's space.

2) Realization of Qualification Authentication:

The user can display the personal ability by uploading personal qualification certificates on the site, so that other users can enter the user's space to view the user's qualification certificates, which can greatly improve the user's recognition on the site, while other users can also “appreciate” the qualification certificates and the user who uploads the qualification certificates can also gain more appreciation.

Before uploading the qualification certificates, the user must pass the real-name authentication.

The user needs to upload the originals and public versions of qualification certificates; the original is used in the review by the administrator and the public version is used to display to other users on the site. After the user submits the qualification certificates, it is required to wait for the review by the administrator and the administrator enters the background to review the original qualification certificates submitted by the user; after passing the review by the administrator, the administrator opens the qualification certificate display permission in the background, so that other users can enter the user's space to view the user's qualification certificates.

3) To ensure that the real-name authentication and qualification authentication functions do not affect the performance of the Web application server and to provide the user with a better experience, the following technologies are used:

(a) Creating a real-name authentication static resource folder ““real name” and a qualification authentication static resource folder “aptitude” on a file server built through a standalone server respectively to store the static resource files uploaded by the user and setting the corresponding read and write permissions for folders respectively;

(b) Creating a second-level domain “user.youshizhishi.com” for the independent access to the real-name authentication and qualification authentication resource files;

(c) Directly uploading the real-name authentication and qualification authentication resource files uploaded by the user to the file server through the second-level domain “user.youshizhishi.com” rather than through the Web application server in the traditional scheme on the site;

(d) To further improve the user's access speed and reduce the load of the Web application server, the second-level domain “user.youshizhishi.com” is accelerated by using CDN so that the source station points to the second-level domain, and to prevent other sites from stealing the resource flow, the second-level domain is configured with a security chain and access white list;

(e) In the developed site code, the real-name authentication and qualification authentication static resource files uploaded by the user and addresses of access to these files directly use the independent second-level domain “user.youshizhishi.com”;

(f) The real-name authentication and qualification authentication module is accelerated through the dynamic and static separation technology and CDN acceleration technology, which not only solves the load pressure of the application server, but also greatly speeds up the user's access, so that the real-name authentication and qualification authentication function can be applied on the site well.

In the above technical programs, in addition to C# language of .NET technology, Java language, PHP language, VB.NET language and Python language can be used; for the data storage technology, in addition to MS SqlServer database, Oracle, Mysql and Mongodb databases can be used.

In the technical realization program of real-name authentication and qualification authentication, the file server can be replaced with the cloud file server that is more popular on the Internet currently, such as Aliyun cloud file server, Baidu cloud file server and Qiniu cloud storage.

The application principle of the disclosure will be further described below in combination with the embodiments.

### EMBODIMENT

How do ordinary users upgrade quickly?

Those who have just registered on the “person of insight” site are ordinary star level users (i.e., level 0).

If the ordinary star level (level 0) user wants to upgrade to level 1, it is required to get at least 100 credits and 10 appreciations.

100 or above credits can be got in many ways, for example, publishing an article. Different credits (+10 credits for the original article, +5 credits for the translated article and +2 credits for the reprinted article) can be got based on the type of the article; therefore, the publishing of original articles is one of the fastest ways to get the credits and 100 credits can be got only by publishing 10 original articles. In addition, the attachment function of the article can also be used as a major source of credits. The practical attachment from the only source is more attractive to users to download and the credits required for the attachment download are determined by the publisher.

Finally, credits can be got by publishing many excellent articles and answering high-quality questions to attract other users to appreciate and comment them and 1 credit is got for comments of a user. This encourages the user to output high-quality contents to attract other users to appreciate and comment them.

Thus, when a user gets 100 and above credits and 10 appreciations, the user star level is upgraded to level 1; when a user gets 200 and above credits and 20 appreciations, the user star level is upgraded to level 2 and so on; when a user gets 500 and above credits and 50 appreciations, the user star level is upgraded to level 5.

After upgrading to ordinary level 5, if the user also wants to upgrade the star level to the authority star level, the real-name authentication is required and the user level can be upgraded to authority level 1 when the user gets 1000 credits and 100 appreciations. Likewise, credits are got by publishing articles, getting comments and downloading attachments.

In general, if a user wants to upgrade as soon as possible, the user needs to constantly output high-quality original articles, provide useful attachment resources and provide popular articles or answers to get more attention and comments, and eventually becomes an expert star level member on the “person of insight” site and a “person of insight” attracting the public attention.

Although the disclosure has been illustrated and described herein with reference to preferred embodiments, it should not be construed as limiting the scope of the disclosure. Any modifications, equivalent substitutions and improvements that are within the spirit and principle of the disclosure are intended to be covered by the protection scope of the disclosure.

1. A method of credit on the social network site, wherein the social level is mapped reasonably and logically by doing statistical analysis of functions used by the user on the site and various credits obtained according to the rules of the site, and the permission of using site functions is divided strictly for the user corresponding to the level, to establish a credit system for the user on the social network site.

2. The method of credit on the social network site according to claim 1, wherein the method of credit on the social network site comprises credit rule and star level setting, wherein the credit rule and star level setting method comprises:
The site user can get a high star level by publishing articles to get the corresponding credits and appreciation number; when a user publishes articles, the corresponding credits are recorded in the database for the user and the user's credits will be accumulated and saved; when the user's articles get the appreciation of other users, the appreciation is accumulated and saved in the field of getting appreciation of the user;
When it is required to display the star level of a user, the user's credits and appreciation number are called by searching session information saved by the user in the database when logging into the site, and the star level rule function is called and the credits and appreciation number are used as the parameters and passed into the function, and then the user's star level is returned through the calculation with the star level definition formula.

3. The method of credit on the social network site according to claim 2, wherein to ensure a good operation of the credit rule and the star level setting on the large-user and high-concurrency site, the credit rule and star level setting method further comprises:
First, the load pressure on the database server brought by the credit rule and appreciation rule is relieved by using the database master-slave separation technology;
Second, the huge load on the database server brought by the operation of clicking appreciation by a large number of users who concurrently access to the site is relieved by using the asynchronous technology and queue technology; after the user clicks appreciation, the appreciations on the page are accumulated with javascript, and then the number is put into the appreciation update queue and updated from the queue to the database, to cancel the high concurrent operation of appreciate function by a large number of users, and the peak clipping processing is carried out to speed up the response to the user.

4. The method of credit on the social network site according to claim 3, wherein the use of the database master-slave separation technology comprises:
The database server is set to master database and slave database;
The user obtains the credits and appreciation number by a large number of write operations and connects the write operation data to the master database;
When the star level is displayed, the user obtains the user's credits and appreciation number from the database and performs the calculation;
When the latest data is read from two database servers with data consistency, the data from the master and slave servers are synchronized.

5. The method of credit on the social network site according to claim 1, wherein the method of credit on the social network site further comprises a real-name authentication method and a qualification authentication method, wherein the real-name authentication method comprises:
After logging into the site, the user uploads the original documents that cannot be altered for applying for the real-name authentication; after the pictures of the uploaded documents are selected, the types of the uploaded documents are also required to be selected, including ID card, passport, driver's license and pass into Hong Kong and Macao; the real name, ID number and phone number are entered; if the information is not filled in completely, the front-end verification and back-end verification on the site page will intercept the user and stop the user to submit the documents;
After the user submits a real name application, it is required to wait for the review by the administrator and the administrator enters the site background to view the information and documents submitted by the user; after it is determined that the documents uploaded and information entered by the user are correct through the review by the administrator, the real-name authentication application of the user is opened in the background; after passing the real-name authentication review, the real-name authentication mark can be seen by entering the user's space;
The qualification authentication method comprises:
Before uploading the qualification certificates, the user needs to pass the real-name authentication.
The user needs to upload the originals and public versions of qualification certificates; after the user submits the qualification certificates, it is required to wait for the review by the administrator and the administrator enters the background to review the original qualification certificates submitted by the user; after passing the review by the administrator, the administrator opens the qualification certificate display permission in the background, so that other users can enter the user's space to view the user's qualification certificates.

6. The method of credit on the social network site according to claim 5, wherein to ensure that the real-name authentication and qualification authentication functions do not affect the performance of the Web application server and to provide the user with a better experience, the method of credit on the social network site further comprises:
(a) Creating a real-name authentication static resource folder real_name and a qualification authentication static resource folder aptitude on a file server built through a standalone server respectively to store the static resource files uploaded by the user and setting the corresponding read and write permissions for folders respectively;
(b) Creating a second-level domain user.youshizhishi.com for the independent access to the real-name authentication and qualification authentication resource files;
(c) Directly uploading the real-name authentication and qualification authentication resource files uploaded by the user to the file server through the second-level domain user.youshizhishi.com on the site;
(d) Accelerating the second-level domain user.youshizhishi.com by using CDN, so that the source station points to the second-level domain and the second-level domain is configured with a security chain and access white list;
(e) In the developed site code, the real-name authentication and qualification authentication static resource files uploaded by the user and addresses of access to these files directly use the independent second-level domain user.youshizhishi.com.
